(19) United States
(12) Patent Application Publication
(10) Pub. No.: US 2006/0146200 A1
(43) Pub. Date: Jul. 6, 2006

(54) Ntsc signal detector

(76) Inventors: Gabriel Alfred Edde, Indianapolis, IN (US); Ivonete Markman, Carmel, IN (US)

Correspondence Address: THOMSON LICENSING INC., PATENT OPERATIONS, PO BOX 5312, PRINCETON, NJ, 08543-5312, US

(21) Appl. No.: 10/536,058

(22) PCT Filed: Nov. 12, 2003
(86) PCT No.: PCT/US03/35904

§ 371 Date: May 24, 2005

Related U.S. Application Data
(60) Provisional application No. 60/429,118, filed on Nov. 26, 2002.

(51) Int. Cl. H04N 5/44; H04L 27/02; H04N 7/173

(52) U.S. Cl. 348/725; 348/731; 725/100; 725/131; 375/270

(57) ABSTRACT

An NTSC (National Television Systems Committee) co-channel interference detector includes at least a carrier tracking loop, peak detector and a D/U (Desired-to-Undesired) signal power ratio estimator. The carrier tracking loop provides a tracking signal representative of the possible presence of a video carrier of an interfering NTSC video signal while the peak detector provides peak data derived from the tracking signal to the D/U signal power ratio estimator. The latter provides, as a function of the peak data, an estimate of a D/U signal power ratio with respect to a desired ATSC (Advanced Television Systems Committee) co-channel signal.

### BACKGROUND OF THE INVENTION

The present invention generally relates to communications systems and, more particularly, to an NTSC signal detector in a receiver.

During the transition from analog to digital terrestrial television in the United States, both analog NTSC (National Television Systems Committee) based transmissions and digital ATSC-HDTV (Advanced Television Systems Committee-High Definition Television) based transmissions are expected to co-exist for a number of years. As such, an NTSC broadcast signal and an ATSC broadcast signal may share the same 6 MHz wide (millions of hertz) channel. This is illustrated in FIG. 1, which shows the relative spectral positions of the NTSC signal carriers (video, audio and chroma) with respect to the digital VSB (Vestigial Sideband) ATSC signal spectrum. Thus, an ATSC receiver must be able to efficiently detect and reject NTSC co-channel interference.

In an ATSC-HDTV digital receiver, NTSC co-channel interference rejection may be performed by the comb filter (e.g., see, United States Advanced Television Systems Committee, “ATSC Digital Television Standard”, Document A/53, Sep. 16, 1995). The comb filter is a 12 symbol linear feed-forward filter with spectral nulls at or near the NTSC signal carriers, and is only applied when NTSC interference is detected (e.g., see, United States Advanced Television Systems Committee, “Guide to the Use of the ATSC Digital Television Standard”, Document A/54, Oct. 04, 1995). Tests have shown that the comb filter performs efficient NTSC signal rejection for D/U (Desired-to-Undesired) signal power ratios up to 16 dB (decibels). The D/U signal power ratio is defined as the average digital VSB ATSC signal power divided by the average NTSC peak signal power.

Since the comb filter is only applied when NTSC interference is detected, it is necessary to first detect the presence of NTSC co-channel interference. Further, it is desirable to be able to detect the NTSC co-channel interference in high D/U ratios. The above-mentioned “Guide to the Use of the ATSC Digital Television Standard,” describes an implementation of an NTSC detector that uses the power difference between the input signal and the output signal of the comb filter. In particular, this implementation detects that an NTSC co-channel signal is present when there is a substantial difference in power between the input signal and the output signal of the comb filter. Unfortunately, this design is not reliable for D/U ratios above 10 dB.

### SUMMARY OF THE INVENTION

In accordance with the principles of the invention, an NTSC detector processes a received signal to provide a tracking signal indicative of a possible presence of a video carrier of an interfering NTSC signal, and provides an estimate of a D/U (Desired-to-Undesired) signal power ratio as a function of peak data derived from the tracking signal.

In an embodiment of the invention, an NTSC detector includes at least a carrier tracking loop, peak detector and a D/U signal power ratio estimator. The carrier tracking loop provides a tracking signal representative of the possible presence of a video carrier of an interfering NTSC video signal while the peak detector provides peak data derived from the tracking signal to the D/U signal power ratio estimator. The latter provides, as a function of the peak data, an estimate of a D/U signal power ratio with respect to a desired ATSC co-channel signal. The estimate of the D/U signal power ratio may be applied to a decision device for determining whether NTSC co-channel interference is present or not.

In another embodiment of the invention, an NTSC detector includes at least a carrier tracking loop, peak detector, a D/U signal power ratio estimator and a horizontal synchronization (sync) detector. The carrier tracking loop provides a tracking signal representative of the possible presence of a video carrier of an interfering NTSC video signal while the peak detector provides peak data derived from the tracking signal to the D/U signal power ratio estimator. The latter provides, as a function of the peak data, an estimate of a D/U signal power ratio with respect to a desired ATSC co-channel signal. In addition, the horizontal sync detector provides a control signal, or sync detection signal, representative of the presence of an NTSC horizontal sync signal. The sync detection signal may be used by the receiver to further improve noise immunity during periods of the horizontal sync signal.

In accordance with the principles of the invention, the above-described NTSC detector can be used by a multimedia receiver, e.g., an ATSC/NTSC receiver, to select one of a number of receiver modes of operation. For example, if the multimedia receiver is attempting to recover data from a received ATSC signal and if the estimate of the D/U power signal ratio provided by the NTSC detector exceeds a predefined threshold, the multimedia receiver then switches in an ATSC comb filter, or similar, for processing of the received ATSC signal to mitigate the presence of an interfering NTSC co-channel signal. Another usage of the NTSC detector is to provide a positive indication to the tuning system of the multimedia receiver that the NTSC detected carrier is in fact the video rather than the aural carrier. A further usage of this NTSC detector is to provide phasing and prediction of the NTSC synchronization signals for providing intelligent noise blanking of the NTSC signal by the multimedia receiver when processing a received ATSC signal.

### BRIEF DESCRIPTION OF THE DRAWINGS

FIG. 1 shows a comparison of an NTSC signal spectrum and a ATSC signal spectrum;

FIG. 2 shows an illustrative high-level block diagram of a TV set embodying the principles of the invention;

FIG. 3 shows a portion of a receiver embodying the principles of the invention;

FIG. 4 shows an illustrative carrier tracking loop for use in the receiver of FIG. 3;

FIG. 5 shows an illustrative graph of the output signal from a carrier tracking loop;

FIG. 6 shows an illustrative averaging filter for use in the receiver of FIG. 3;

FIG. 7 shows an illustrative graph of the output signal from the averaging filter of FIG. 6;

FIG. 8 shows an illustrative duty cycle DC restorer for use in the receiver of FIG. 3;

FIG. 9 shows an illustrative graph of a restored signal from the duty cycle DC restorer of FIG. 8;

FIG. 10 shows an illustrative table for use in LUT 188 of FIG. 3;

FIG. 11 shows an illustrative flow chart in accordance with the principles of the invention;

FIG. 12 shows an illustrative graph of an sync detector output signal;

FIG. 13 shows another embodiment in accordance with the principles of the invention; and

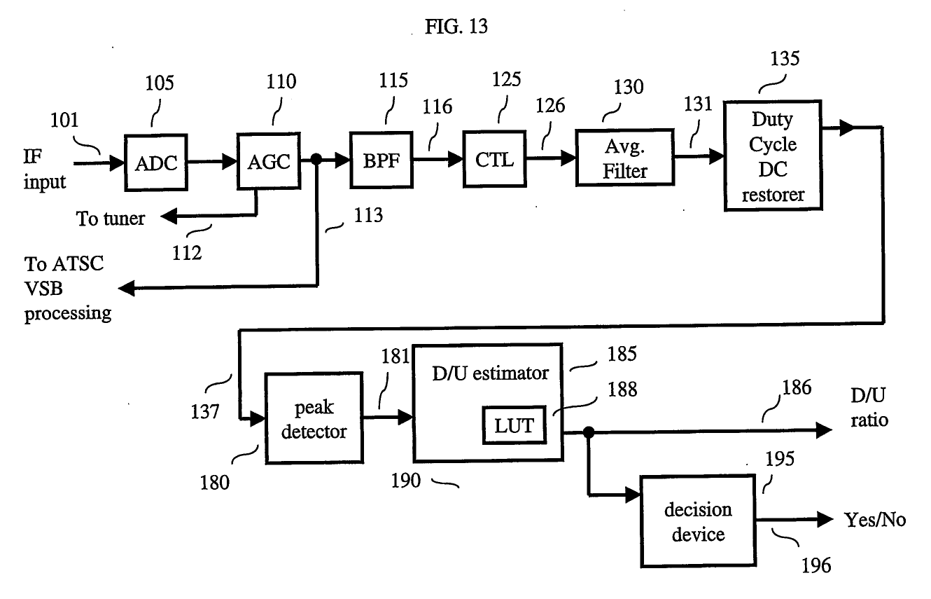

FIG. 14 shows another illustrative flow chart in accordance with the principles of the invention.

### DETAILED DESCRIPTION

Other than the inventive concept, the elements shown in the figures are well known and will not be described in detail. For example, other than the inventive concept, a television, and the components thereof, such as a front-end, Hilbert filter, carrier tracking loop, video processor, remote control, etc., are well known and not described in detail herein. In addition, the inventive concept may be implemented using conventional programming techniques, which, as such, will not be described herein. Finally, like-numbers on the figures represent similar elements.

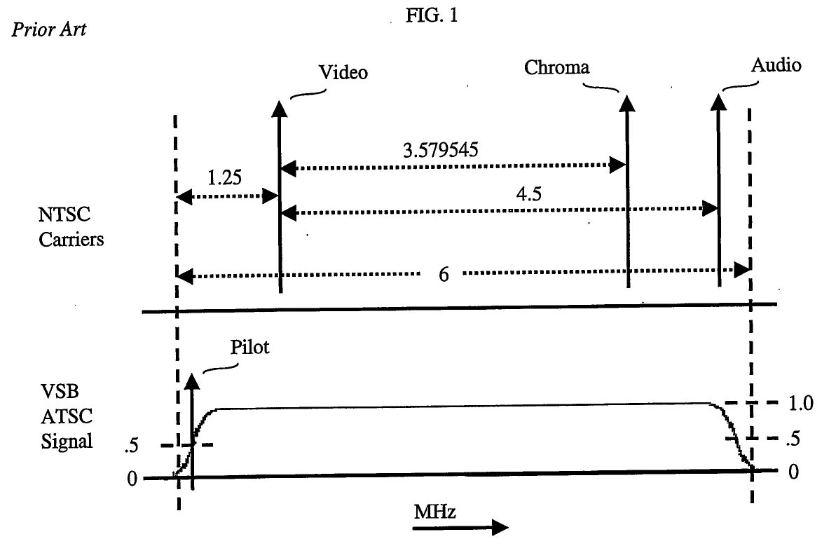

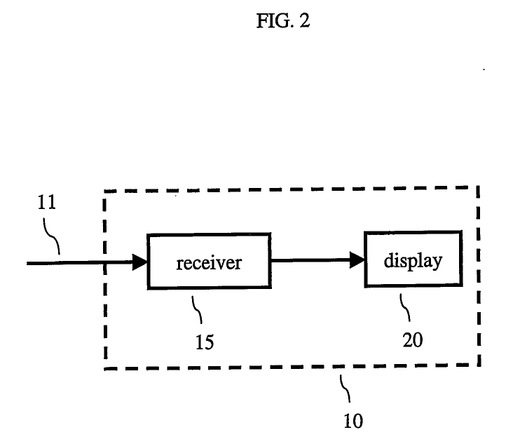

A high-level block diagram of an illustrative television set 10 in accordance with the principles of the invention is shown in FIG. 2. Television (TV) set 10 includes a receiver 15 and a display 20. Illustratively, receiver 15 is an ATSC-compatible receiver. It should be noted that receiver 15 may also be NTSC-compatible, i.e., have an NTSC mode of operation and an ATSC mode of operation such that TV set 10 is capable of displaying video content from an NTSC broadcast or an ATSC broadcast. In this regard, receiver 15 is an example of a multimedia receiver. However, in the context of this description, the ATSC mode of operation is described. Receiver 15 receives a broadcast signal 11 (e.g., via an antenna (not shown)) for processing to recover therefrom, e.g., an HDTV video signal for application to display 20 for viewing video content thereon. As noted above, and shown in FIG. 1, signal 11 may include not only a broadcast ATSC signal but also interference from a co-channel broadcast NTSC signal. In this regard, receiver 15 of FIG. 2 includes a rejection filter (not shown), such as the above-mentioned comb filter, for removing the NTSC signal interference as described above and, in accordance with the principles of the invention, also includes an NTSC detector.

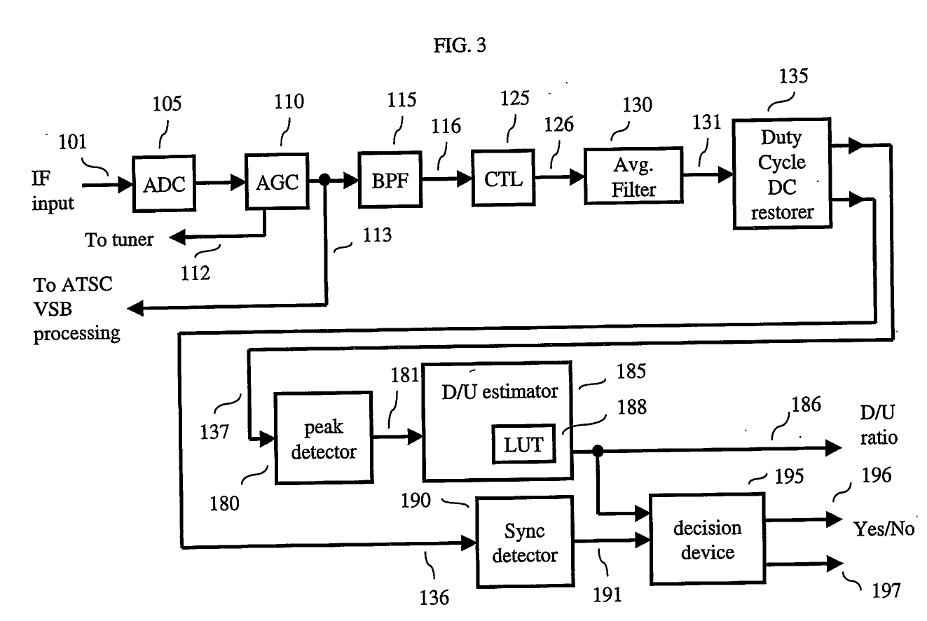

Turning now to FIG. 3, that relevant portion of receiver 15 including an NTSC detector in accordance with the principles of the invention is shown. In particular, receiver 15 includes band-pass filter (BPF) 115, carrier tracking loop (CTL) 125, averaging (avg.) filter 130, duty cycle DC restorer 135 (hereafter restorer 135), peak detector 180, D/U estimator 185, sync detector 190 and decision device 195.

Input signal 101 represents a digital VSB modulated signal in accordance with the above-mentioned “ATSC Digital Television Standard” and is centered at a specific IF (Intermediate Frequency) of f_{IF} Hertz. However, as also noted above, input signal 101 may also contain NTSC co-channel interference. Input signal 101 is sampled by ADC 105 for conversion to a sampled signal, which is then gain controlled by AGC 110. The latter is noncoherent and is a mixed mode (analog and digital) loop that provides a first level of gain control (prior to carrier tracking), symbol timing and sync detection of the VSB signal included within signal 101. AGC 110 basically compares the absolute values of the sampled signal from ADC 105 against a predetermined threshold, accumulates the error and feeds that information, via signal 112, back to the tuner (not shown) for gain control prior to ADC 105. As such, AGC 110 provides a gain controlled signal 113 to ATSC VSB processing circuitry (not shown) and to BPF 115. In accordance with a feature of the invention, BPF 115 is centered at the NTSC video carrier and has a narrow bandwidth less than or equal to 600 KHz (thousands of hertz). Assuming no transmitted offsets between the VSB signal and a co-channel NTSC signal, and assuming high side injection, the NTSC video carrier is expected to be at a frequency, f_{VIDEO}, where f_{VIDEO}=f_{IF}−1.75 MHz.

The output signal 116 from BPF 115 is applied to carrier tracking loop (CTL) 125, which is a phase locked loop that processes the complex sample stream of signal 116 to down convert the IF signal to baseband and correct for frequency offsets between the transmitter (not shown) of the broadcast NTSC video carrier and the receiver tuner Local Oscillator (not shown). CTL 125 is a second order loop, which, in theory, allows for frequency offsets to be tracked with no phase error. In practice, phase error is a function of the loop bandwidth, input phase noise, thermal noise and implementation constraints like bit size of the data, integrators and gain multipliers.

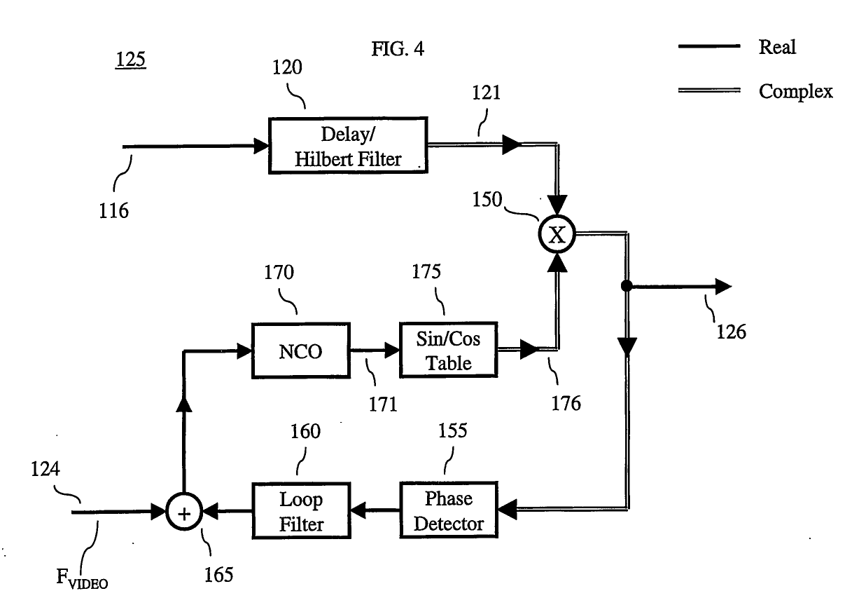

Turning for the moment to FIG. 4, an illustrative embodiment of CTL 125 is shown. CTL 125 includes delay/Hilbert filter element 120, complex multiplier 150, phase detector 155, loop filter 160, combiner (or adder) 165, numerically controlled oscillator (NCO) 170 and sine/cosine (sin/cos) table 175. It should be noted that other carrier tracking loop designs are possible, as long as they achieve the same performance. Delay/Hilbert filter element 120 includes a Hilbert filter and an equivalent delay line that matches the Hilbert filter processing delay. As known in the art, a Hilbert Filter is an all-pass filter that introduces a −90° phase shift to all input frequencies greater than 0 (and a +90° degree phase shift to negative frequencies). The Hilbert filter allows recovery of the quadrature component of the output signal 116 from BPF 115. In order for the CTL to correct the phase and lock to the NTSC video carrier both the in-phase and quadrature components of the signal are needed. The output signal 121 from delay/Hilbert filter element 120 is a complex sample stream comprising in-phase (I) and quadrature (Q) components. It should be noted that complex signal paths are shown as double lines in the figures. Complex multiplier 150 receives the complex sample stream of signal 121 and performs de-rotation of the complex sample stream by a calculated phase angle. In particular, the in-phase and quadrature components of signal 121 are rotated by a phase. The latter is provided by signal 176, which represents particular sine and cosine values provided by sin/cos table 175 (described below). The output signal from complex multiplier 150, and for that matter CTL 125, is down-converted received signal 126, which represents a de-rotated complex sample stream. Signal 126 is also referred to herein as the tracking signal. As can be observed from FIG. 4, down-converted received signal 126 is also applied to phase detector 155, which computes any phase offset still present in the down-converted signal 126 and provides a phase offset signal indicative thereof. This computation can be performed with a “I*Q” or a “sign(I)*Q” function. The phase offset signal provided by phase detector 155 is applied to loop filter 160, which is a first order filter with proportional-plus-integral gains. Ignoring for the moment combiner 165, the loop filtered output signal from loop filter 160 is applied to NCO 170. The latter is an integrator, which takes as an input signal a frequency, and provides an output signal representative of phase angles associated with the input frequency. However, in order to increase the acquisition speed, the NCO is fed a frequency offset, F_{OFFSET}, corresponding to F_{VIDEO}, which is added to the loop filter output signal via combiner 165 to provide a combined signal to NCO 170. NCO 170 provides an output phase angle signal 171 to sin/cos table 175, which provides the associated sine and cosine values to complex multiplier 150 for de-rotation of signal 121 to provide tracking signal 126, which corresponds to the in-phase (real) component of the complex signal from multiplier 150.

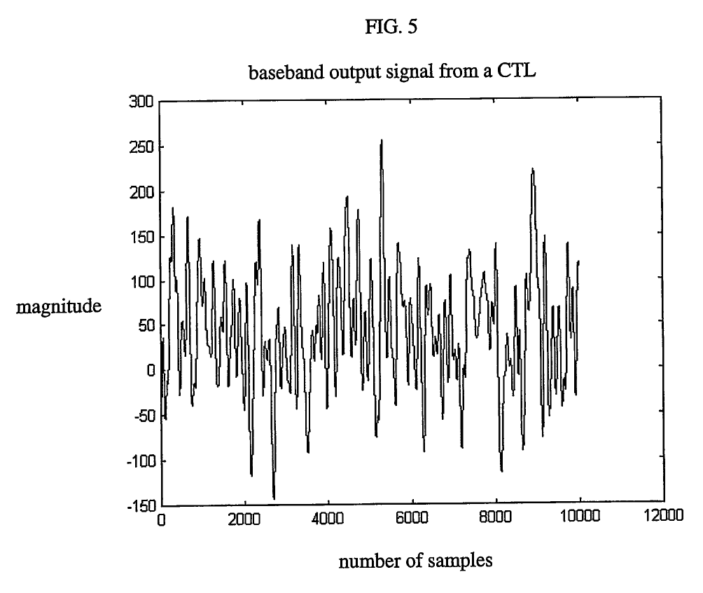

It should be noted that a received ATSC signal looks like random white noise when viewed with a spectum analyzer over an entire 6 MHz channel channel. Thus, when bandlimited to 600 kHz around the NTSC carrier, e.g., via BPF 115, the ATSC signal (e.g., signal 116) appears as white random zero mean noise at the input of the CTL. Since the CTL behaves as a coherent double sideband AM demodulator, the spectrum of the baseband video is 300 kHz, which is ½ the 600 kHz bandpass spectrum due to the natural spectral folding of the CTL. FIG. 5 shows an illustrative graph of a signal at the output of a CTL, where magnitude of the output signal (e.g., signal 126) is along the y-axis and the number of samples (time) is along the x-axis. It can be observed,that the output signal from the CTL looks like pure noise. In addition, the actual noise component of this output signal has zero mean.

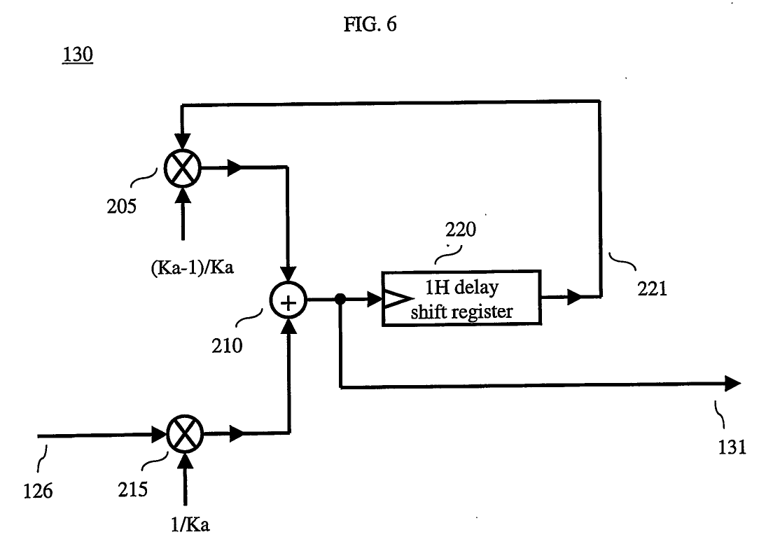

Returning now to FIG. 3, tracking signal 126 is applied to averaging (avg.) filter 130 to pull out further signal detail. FIG. 6 shows an illustrative block diagram of avg. filter 130. The latter is a cyclical averaging filter and includes multipliers 205 and 215, adder (or combiner) 210 and 1H delay shift register 220 (1H corresponds to the period of an NTSC horizontal line). This filter calculates a running weighted average of the input signal, here tracking signal 126. As used herein, “cyclical” means that the input signal is averaged such at intervals of 1H each sample is averaged together with a particular weighting. As can be observed from FIG. 5, avg. filter 130 implements the following illustrative equation:
out(n)=in(n)/Ka+buffer(n)*(Ka−1)/Ka. (1)
Where in(n) is the input data, i.e., a stream of samples as represented by signal 126 in FIG. 6; out(n) is the output data, i.e., signal 131; buffer(n) represents the running average provided by 1H delay shift register 220, i.e., signal 221. Ka is an averaging constant (i.e., “the number of horizontal lines averaged”) and illustratively has a value of 100. It should be noted that use of a conventional lowpass filter as an averaging filter requires a very long time constant and smears the detail of any NTSC sync structure present in tracking signal 126. In contrast, a filter (such as avg. filter 130) that averages each sample point at 1H intervals preserves the sync structure and provides the ability to average out the noise component of the signal. It should also be noted that there are many cyclical filter functions that could be used which would work in this application. The simple running average illustrated by avg. filter 130 was picked since it is easy to implement (e.g., does not require very much memory) and weights older samples less than newer ones.

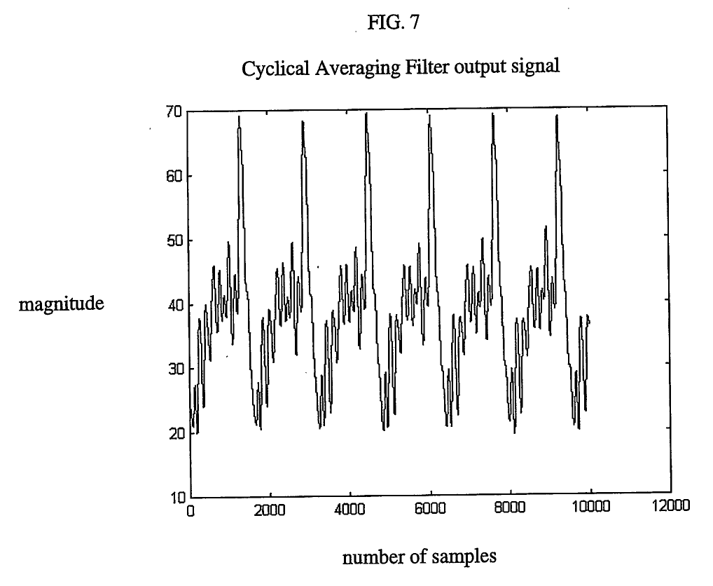

FIG. 7 shows an illustrative graph of output signal 131 of avg. filter 130 with a 16 dB D/U signal (i.e., the average ATSC signal power to peak NTSC power ratio is 16 dB). The magnitude of output signal 131 is along the y-axis and the number of samples (time) is along the x-axis. As noted above, the averaging constant, Ka, has an illustrative value of 100. It can be observed from FIG. 7 that the NTSC horizontal sync has emerged from the noisy input signal (sync is active high in the graph of FIG. 7). The lower part of output signal 131 is averaged NTSC video. The rounded nature of the horizontal sync signal is due to the initial 600 kHz BPF 115, which was used to filter out as much noise as possible before application of the received signal to CTL 125 but still have enough bandwidth to be able to detect the sync signal. It can be observed from FIG. 7 that avg. filter 130 performs a kind of an envelope detection of the NTSC video signal.

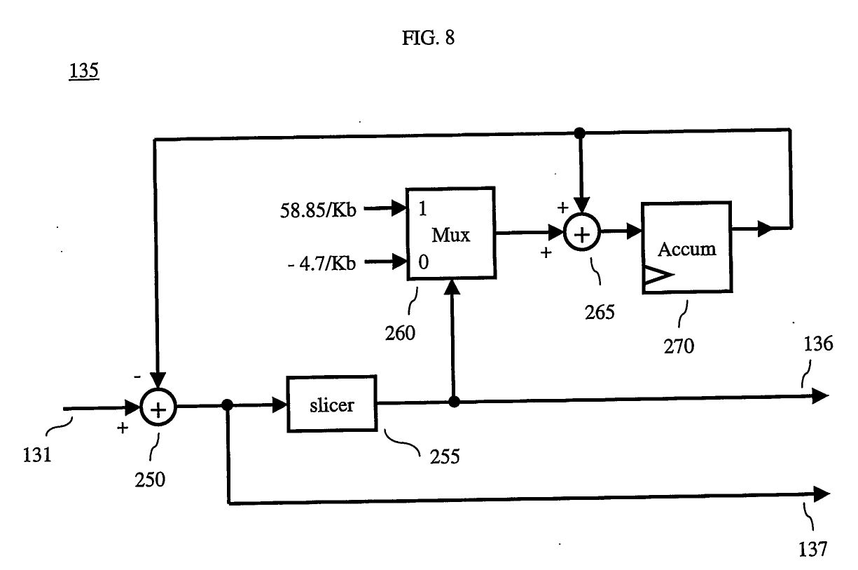

Returning to FIG. 3, output signal 131 is then applied to restorer 135 for DC restoration, i.e., removal of any DC offset after envelope detection. FIG. 8 shows an illustrative block diagram of restorer 135, which includes adders, or combiners, 250 and 265, slicer 255, multiplexer (mux) 260 and accumulator 270. As can be observed from FIG. 8, restorer 135 provides a restored signal 137 and a sliced output signal 136. The latter is provided by slicer 255, which is basically a quantizer such that sliced output signal 136 is illustratively a “logical 1” when the restored signal 137 is greater than zero and a “logical 0” otherwise. Restorer 135 restores the DC offset so the “zero crossing” is at a specific duty cycle. In this example, the duty cycle is picked at a ratio of 4.7 to 58.85 which is the ratio of the NTSC horizontal sync to the rest of the NTSC horizontal line. That way, restorer 135 seeks and restores to the middle of the filtered horizontal sync signal. In particular, restorer 135 works by using a weighted average scheme that adds an accumulated value based on the time the sliced output signal 136 is high or low. When the sliced output signal 136 is a “logical 1,” mux 260 applies 58.85/Kb to adder 265; and when the sliced output signal 136 is a “logical 0,” mux 260 applies 4.7/Kb to adder 265. Restorer 135 seeks the equilibrium point where: (slicer_high_time*58.85)=(slicer_low_time*4.7). The Kb speed constant determines the speed (or the inertial lag) of the correction. Larger values of Kb make better (smoother) DC offset value estimates but restorer 135 takes a longer time to converge. Smaller values of Kb make the DC offset value estimates noisier but restorer 135 then converges quickly. In simulations, an illustrative value of Kb=10000 gave reasonable DC restored convergence times of a few milliseconds.

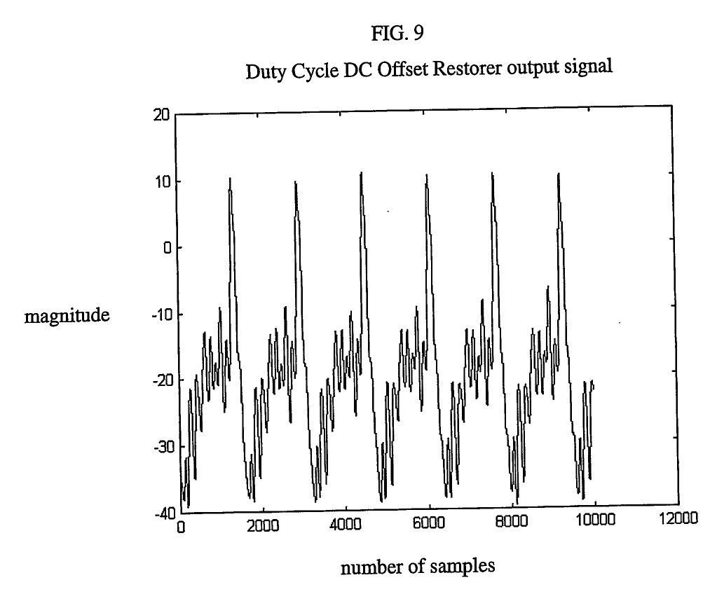

FIG. 9 shows an illustrative graph of restored signal 137. The magnitude of restored signal 137 is along the y-axis and the number of samples (time) is along the x-axis. We have observed that if the automatic gain control of the receiver is referenced to the power of the 600 kHz bandpass channel—which is dominated by the ATSC signal—the amplitude of restored signal 137 is inversely proportional to above described D/U ratio. Thus, and in accordance with the principles of the invention, looking at the amplitude of restored signal 137 gives an estimate of the D/U ratio for recevier 15 to use. Illustratively, a good estimate of the NTSC signal level can be obtained by looking at the peak of the NTSC sync with respect to the zero crossing, which is basically proportional to the NTSC signal amplitude. In FIG. 9, the peaks are at approximately 10 units for a 16 dB D/U ratio.

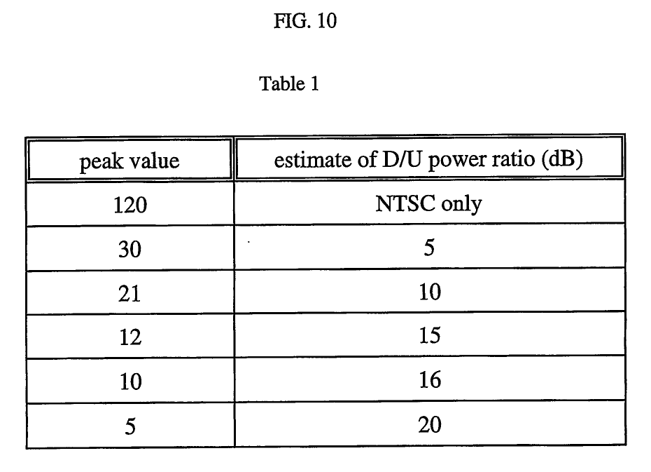

Referring back to FIG. 3, restored signal 137 is applied to peak detector 180 for use in estimating the D/U signal power ratio of the ATSC signal to the NTSC signal. Peak detector 180 detects the signal peaks of restored signal 137 and provides these peak values, via signal 181, to D/U estimator 185. Thus, peak detector 180, in effect, detects the signal peaks of tracking signal 126. D/U estimator 185 includes look-up-table (LUT) 188, which is provided, e.g., by a memory (not shown). D/U estimator 185 maps peak data from peak detector 180 to an estimated D/U power ratio, which is represented by D/U power ratio signal 186. In other words, a peak data value is used as an index into LUT 188. An illustrative set of values for storage in LUT 188 is shown in table 1 of FIG. 10. The illustrative values shown in Table 1 were determined from simulations. Table 1 includes at least two columns, one column storing the magnitude of peak values that may be provided by peak detector 181, the other column storing estimated D/U power ratios. For example, if a peak value from detector 181 is 10, then D/U estimator 185 provides a D/U power ratio signal 186 representing an estimated D/U power ratio value of 16 dB. For peak values from peak detector 180 other than the discrete values shown in Table 1, D/U estimator 185 may, e.g., simply quantize the received peak value to the closet peak value entry of Table 1. The D/U power ratio signal 186 is provided to other portions of receiver 15 (not shown) and to decision device 195 (described below).

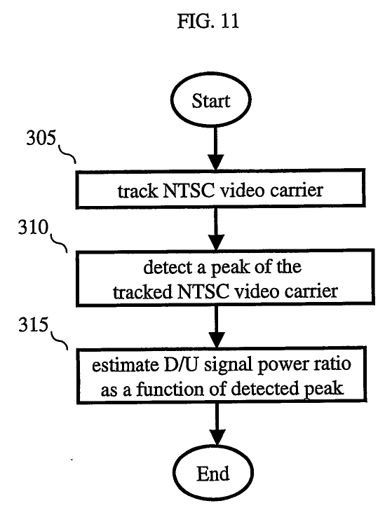

An illustrative flow chart in accordance with the principles of the invention is shown in FIG. 11. In step 305, receiver 15 processes a received signal to track an NTSC video carrier. In step 310, receiver 15 detects a peak value of the tracked NTSC video carrier. In step 315, receiver 15 provides an estimated D/U signal power ratio as a function of the detected peak value.

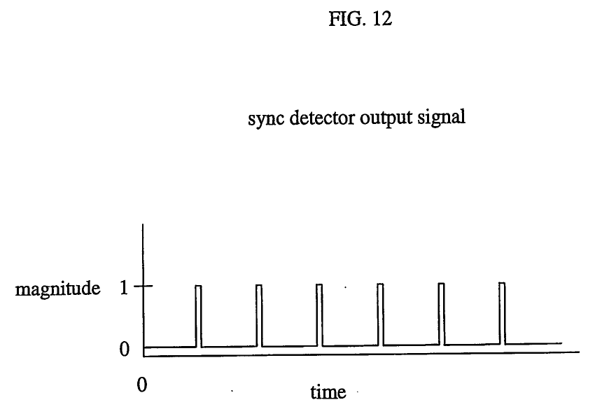

Turning back to FIG. 3, sliced output signal 136 is applied to sync detector 190, which is used to determine the presence of the NTSC horizontal sync signal and provide a signal 191 representative of the detection of NTSC horizontal sync at a point in time (signal 191 may also be referred to as a sync detection signal). Sync detector 190 is illustratively period counter based. FIG. 12 shows an illustrative graph of output signal 191 from sync detector 190. The magnitude is along the y-axis and time is along the x-axis. Essentially, sync detector 190 provides a signal greater than 0, e.g., a logical “1”, when the restored signal 137 is greater than zero and provides a signal of value 0, e.g., a logical “0,” when the restored signal 137 is less than zero.

Signal 191 and D/U power ratio signal 186 are provided to decision device 195. The latter provides a simple “yes ” or “no” indication (e.g., a logical “1” or a logical “0”) as a function of one or both signal 191 and D/U power ratio signal 186. The function of decision device 195 changes depending on application and can be used by a multimedia receiver, e.g., an ATSC/NTSC receiver such as represented by receiver 15 of FIG. 1, to select one of a number of receiver modes of operation. For example, decision device 195 may simply determine whether an NTSC co-channel is present, e.g., provide a “yes” if the estimated D/U power ratio is not 0 and provide a “no” if the estimated D/U power ratio represents a zero value. In this example, decision device 195 ignores signal 191 from sync detector 190. Or, decision device 195 may determine, via signal 196, whether or not NTSC co-channel interference is large enough to warrant switching in the earlier-described comb filter if the estimated D/U power ratio is smaller than a predefined D/U power ratio threshold. Indeed, decision device 195 may decide when to switch from demodulating the received ATSC signal to demodulating the received NTSC signal as a function of the estimated D/U power ratio, e.g., if D/U power ratio signal 186 is greater than a second predefined D/U power ratio threshold. Alternatively, decision device 195 may provide other signals such as signal 197. For example, signal 197 is a “blanking” signal provided to other portions (not shown) of receiver 15 to indicate the presence of an NTSC horizontal sync signal when the estimated D/U power ratio is smaller than a predefined value (i.e., depending on the strength of the NTSC co-channel interference). In particular, the NTSC horizontal sync is the “loudest” portion of the NTSC signal. As such, the NTSC detector described herein is capable of detecting the NTSC horizontal sync and then providing this information (of when the sync is present in the received signal) to the ATSC VSB portion (not shown) of receiver 15, which may be able to improve performance by windowing that portion of the received signal in some of the receiver algorithms, e.g., to stop algorithms from running during the presence of the horizontal sync. Such portions/algorithms of the receiver may include: the carrier tracking loop (CTL), symbol timing recovery (STR), equalization, forward error correction (FEC), etc. One or more of these portions/algorithms may be inhibited from updating (that is, they may blank that data portion) since there is high likelihood that this horizontal sync signal interference on the received ATSC VSB signal will create erroneous information. Another usage of the NTSC detector is to provide a positive indication to the tuning system of the multimedia receiver that the NTSC detected carrier is in fact the video rather than the aural carrier. While decision device 195 may be as simple as, e.g., a comparator, it is assumed that decision device 195 is representative of, e.g., a stored-program-controlled processor that takes D/U power ratio signal 186 and signal 191 and uses them as a real time aid in optimizing reception modes of receiver 15.

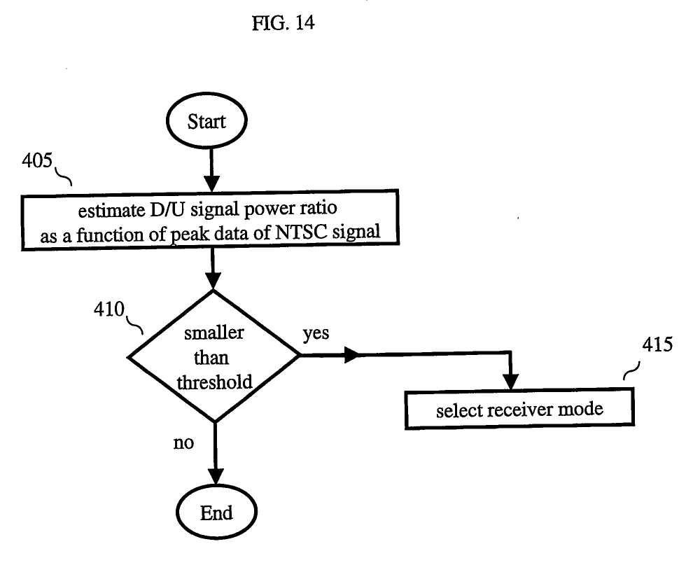

In light of the above, an illustrative flow chart in accordance with the principles of the invention is shown in FIG. 14. In step 405, receiver 15 estimates the D/U signal power ratio as a function of peak data from the received NTSC signal (as described above). In step 410, receiver 15 compares the estimated D/U power ratio to at least one threshold D/U power ratio value. If the estimated D/U power ratio is smaller than the threshold, then receiver 15 selects a receiver mode (as illustrated immediately above) in step 415. As noted above, although not shown in FIG. 14, the threshold comparison in step 410 may also include reference to the presence, or lack thereof, of the NTSC horizontal sync. signal for subsequent selection of the receiver mode in step 415.

Thus, and in accordance with the principles of the invention, the NTSC detector described herein provides the ability to estimate D/U power signal ratios and/or the NTSC horizontal sync signal such that the receiver can better recover from noise, distortion and interference due to NTSC co-channel interference. In particular, the above-described NTSC detector extracts information regarding the presence of NTSC co-channel interference by performing something like an envelope detection on the NTSC signal with emphasis on the horizontal sync signal after carrier tracking of the NTSC video carrier.

Another embodiment in accordance with the principles of the invention is shown in FIG. 11. This embodiment is similar to that of FIG. 3 except that restorer 135 is not required to provide a sliced output signal 136 since decision device 195 makes a decision (described above) based on the D/U power ratio signal 186. It should also be noted that groupings of components for particular elements described and shown herein are merely illustrative. For example, although FIG. 4 shows a Hilbert filter internal to the carrier tracking loop, this is not required and, e.g., the Hilbert filter could have been shown as external to the carrier tracking look and described as a part of FIG. 3.

As such, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied on one or more integrated circuits (ICs). Similarly, although shown as separate elements, any or all of the elements may be implemented in a stored-program-controlled processor, e.g., a digital signal processor or microprocessor, which executes associated software, e.g., corresponding to one or more of the steps shown in FIG. 11 and/or FIG. 14. In this regard, the above-described decision device 195 may be representative of one or more software subroutines that processes the estimated D/U power ratio. Further, although shown as elements bundled within TV set 10, the elements therein may be distributed in different units in any combination thereof. For example, receiver 15 may be a part of a device, or box, physically separate from the device, or box, incorporating display 20, etc. It is therefore to be understood that numerous modifications may be made to the illustrative embodiments and that other arrangements may be devised without departing from the spirit and scope of the present invention as defined by the appended claims.

1. A method for use in detecting a signal in a multimedia receiver, the method comprising:
providing a tracking signal indicative of a possible presence of a video carrier of an interfering signal; and
providing an estimate of a Desired-to-Undesired (D/U) power ratio as a function of peak data derived from the tracking signal.

2. The method of claim 1, further comprising the step of selecting a mode of the multimedia receiver as a function of a comparison of the estimate of the D/U power ratio to at least one predefined D/U power ratio threshold.

3. The method of claim 2, wherein the selecting a mode step includes the steps of:
comparing the estimate of the D/U power ratio to the at least one predefined D/U power ratio threshold; and
if the estimate of the D/U power ratio is smaller than the at least one predefined D/U power ratio threshold, selecting the mode of the multimedia receiver.

4. The method of claim 2, wherein the selected mode of the multimedia receives enables a comb filter of the multimedia receiver for mitigating NTSC co-channel interference.

5. The method of claim 2, wherein the selected mode of the multimedia receiver switches from demodulating a received ATSC (Advanced Television Systems Committee) signal to demodulating an NTSC signal.

6. The method of claim 1, further comprising the step of detecting a horizontal synchronization (sync) signal of the signal to provide a sync detection signal representative thereof.

7. The method of claim 6, further comprising the step of inhibiting at least one process of the multimedia receiver as a function of the sync detection signal.

8. The method of claim 6, further comprising the step of inhibiting the at least one process when an estimate of the D/U power ratio is smaller than at least one predetermined D/U power ratio threshold and the sync detection signal indicates the presence of the horizontal sync.

9. The method of claim 1, where the step of providing an estimate of the Desired-to-Undesired (D/U) power ratio includes the steps of:
averaging the tracking signal to provide an averaged tracking signal;
removing any DC offset present in the averaged tracking signal to provide a restored signal;
detecting a peak value of the restored signal; and
providing the estimate of the D/U power ratio as a function of the detected peak value.

10. The method of claim 9, wherein the step of providing the estimate of the D/U power ratio as a function of the detected peak value step includes the step of using the detected peak value as an index into a look-up table storing predefined estimated D/U power ratios for providing the estimate of the D/U power ratio.

11. Apparatus for use in a multimedia receiver for detecting a presence of a signal in a received signal, the apparatus comprising:
a carrier tracking loop for tracking the signal in the received signal to provide a tracking signal;
a peak detector for providing peak data derived from the tracking signal; and
an estimator for providing an estimate of a Desired-to-Undesired (D/U) power ratio as a function of the peak data.

12. The apparatus of claim 11, wherein the peak detector includes:
an averaging filter for filtering the tracking signal to provide an averaged signal;
a DC restorer for processing the averaged signal to remove any DC offset present in the averaged signal to provide a restored signal; and
a peak value detector for detecting a peak value of the restored signal and for providing the peak value as peak data to the estimator.

13. The apparatus of claim 11, wherein the estimator includes a look-up table for use in mapping the peak data to predefined estimates of D/U power ratios.

14. The apparatus of claim 11, further comprising a decision device for use in selecting one of a number of modes of the multimedia receiver as a function of a comparison of the estimate of the D/U power ratio to at least one predefined D/U power ratio threshold.

15. The apparatus of claim 14, wherein the decision device is a stored-program-controlled processor.

16. The apparatus of claim 14, wherein the decision device compares the estimate of the D/U power ratio to the at least one predefined D/U power ratio threshold; and, if the estimate of the D/U power ratio is smaller than the at least one predefined D/U power ratio threshold, selects the mode of the multimedia receiver.

17. The apparatus of claim 14, wherein the selected mode of the multimedia receives enables a comb filter of the multimedia receiver for mitigating NTSC co-channel interference.

18. The apparatus of claim 14, wherein the selected mode of the multimedia receiver switches from demodulating a received ATSC (Advanced Television Systems Committee) signal to demodulating an NTSC signal.

19. The apparatus of claim 14, further including an NTSC horizontal synchronization (sync) detector for detecting NTSC horizontal sync and providing a sync detection signal representative thereof; and wherein the decision device provides a blanking signal when an estimate of the D/U power ratio is smaller than at least one predetermined D/U power ratio threshold and the sync detection signal indicates the presence of the horizontal sync; wherein the blanking signal if for inhibiting at least one process of the multimedia receiver.

20. The apparatus of claim 14, further including an NTSC horizontal synchronization (sync) detector for detecting NTSC horizontal sync and providing a sync detection signal representative thereof; and wherein the decision device provides a blanking signal when the sync detection signal indicates the presence of the horizontal sync, wherein the blanking signal if for inhibiting at least one process of the multimedia receiver.
